(19) United States
(12) Patent Application Publication
(10) Pub. No.: US 2007/0160251 A1
(43) Pub. Date: Jul. 12, 2007

(54) Removable earpiece

(75) Inventor: Tyronne Gerard Gabriel, Canoga Park, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Metric Products, Inc.

(21) Appl. No.: 11/329,674

(22) Filed: Jan. 10, 2006

(51) Int. Cl. H04R 25/00

(52) U.S. Cl. 381/378; 381/370

(57) ABSTRACT

A first earpiece has a first side and a second side. A loop portion is connected to the second side. The first side includes a hollowed ear portion adapted to fit over a person's ear. The first earpiece is moldable in a multitude of shapes when a force is applied and returns to an original shape when the force is removed.

### BACKGROUND

1. Field

The embodiments relate to earphones, and more particular to a removable earpiece adapted to be attached to a strap of an eyeshade.

2. Description of the Related Art

There are many types of earpieces/earphones/headphones that allow a person to listen to music/sound or to prevent a person from hearing sound. Headphones are bulky and cannot easily be stored in small areas. Earphones can become very uncomfortable over a period of time. When traveling, headphones, headsets, etc. can easily become broken if stored in a tight fitting area. Earplugs can cause discomfort and irritation when inserted in a person's ear. Other hearing devices, such as wireless earphones loop over a person's ear, which can cause irritation over time and are also rigid. If a person is wearing a rigid earphone or headphone positions their head to where the rigid earphone or headphone is pressed against a surface, such as a seat, the speaker or outer portion of the device presses against a person's ear or head which is uncomfortable or irritable.

### SUMMARY

One embodiment includes a first earpiece having a first side and a second side. A loop portion is connected to the second side. The first side includes a hollowed ear portion adapted to fit over a person's ear, and the first earpiece is moldable in various shapes when a force is applied and returns to its original shape when the force is removed.

Another embodiment includes an earpiece system. The system includes a first removable earpiece and a second removable earpiece. The first and second removable earpieces each have a first side and a second side. A first coupling loop is connected to the first removable earpiece. A second coupling loop is connected to the second removable earpiece.

And yet another embodiment includes a headphone system having a first removable earpiece and a second removable earpiece. The first and second removable earpieces each have a first side, a second side and a loop portion. Each of the first earpiece and the second earpiece are sized to fit over a person's ear without touching the person's ear.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1 illustrates an embodiment of a removable earpiece.

FIG. 2 illustrates a front view of the embodiment illustrated in FIG. 1.

FIG. 3 illustrates a rear view of the embodiment illustrated in FIG. 1.

FIG. 4 illustrates a right side view of the embodiment illustrated in FIG. 1.

FIG. 5 illustrates a left side view of the embodiment illustrated in FIG. 1.

FIG. 6 illustrates a bottom view of the embodiment illustrated in FIG. 1 as viewed on a person's head.

FIG. 7 illustrates a perspective view of the embodiment illustrated in FIG. 1 as viewed on a person's head.

FIG. 8 illustrates a front view of the embodiment illustrated in FIG. 1 as viewed on a person's head.

FIG. 9 illustrates a rear view of the embodiment illustrated in FIG. 1 as viewed on a person's head.

FIG. 10 illustrates a top plan view of the embodiment illustrated in FIG. 1 as viewed on a person's head.

FIG. 11 illustrates a perspective view of the embodiment illustrated in FIG. 1 including a headphone cord.

FIG. 12 illustrates a front view of the embodiment illustrated in FIG. 1 including a headphone cord.

FIG. 13 illustrates a rear view of the embodiment illustrated in FIG. 1 including a headphone cord.

FIG. 14 illustrates a right side view of the embodiment illustrated in FIG. 1 including a headphone cord.

FIG. 15 illustrates a left side view of the embodiment illustrated in FIG. 1 including a headphone cord.

FIG. 16 illustrates a top plan view of the embodiment illustrated in FIG. 1 including a headphone cord.

FIG. 17A illustrates a perspective view of an embodiment of a removable earpiece including a speaker and a headphone cord.

FIG. 17B illustrates a side cutout view of an embodiment of a removable earpiece including a speaker and a headphone cord.

FIG. 17C illustrates a front side view of an embodiment of a removable earpiece including a speaker and a headphone cord.

FIG. 18A illustrates an embodiment of a removable earpiece with a slide on loop.

FIG. 18B illustrates an embodiment of a removable earpiece with a hook and loop attaching means.

### DETAILED DESCRIPTION OF THE INVENTION

The invention generally relates to removable earpieces adapted to attach to a strap, such as a strap of an eyeshade. Referring to the figures, exemplary embodiments of the invention will now be described. The exemplary embodiments are provided to illustrate the invention and should not be construed as limiting the scope of the invention.

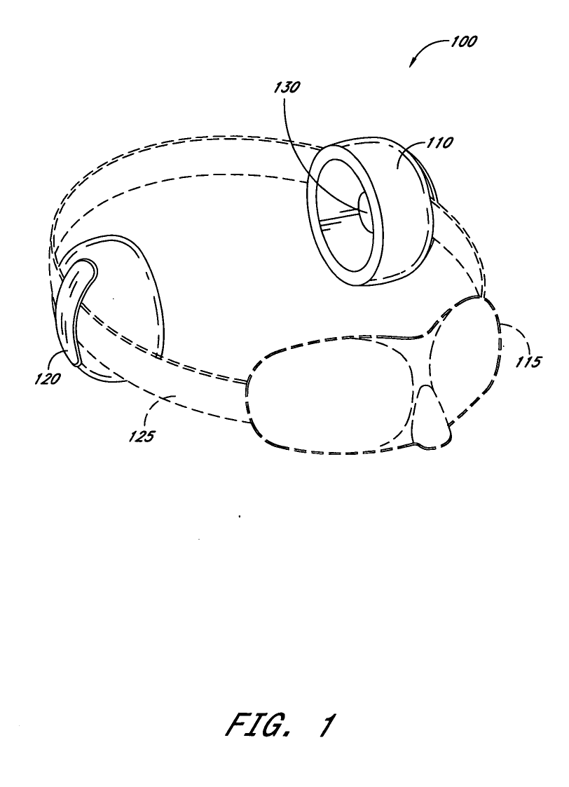

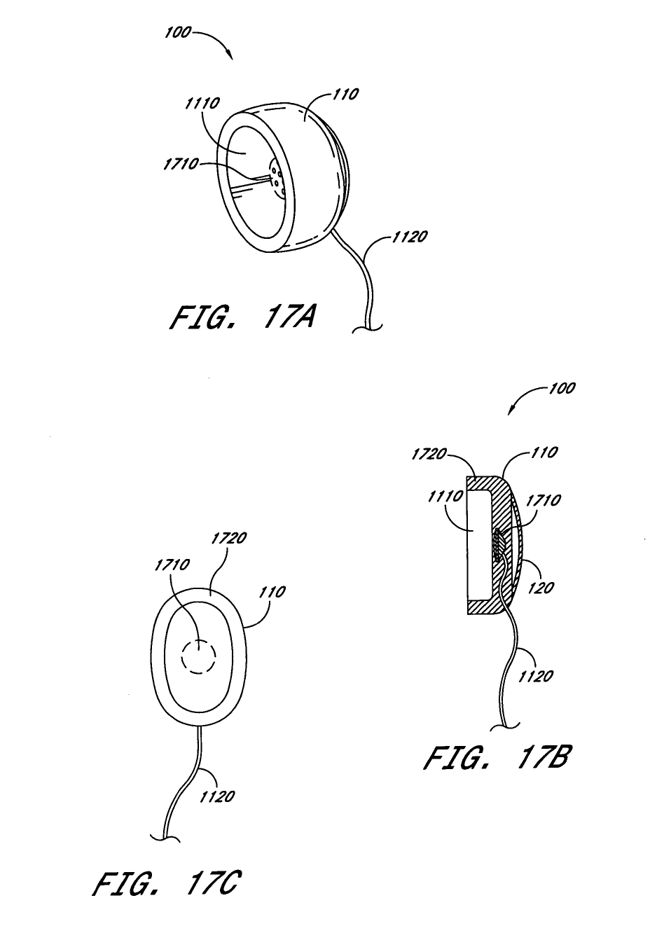

FIG. 1 illustrates an embodiment of a removable earpiece. Removable earpiece 100 includes first side 130, second side 110 and loop portion 120, which is attached to second side 110. In one embodiment first side 130 includes a hollowed ear portion adapted to fit over a person's ear. In this embodiment, earpiece 100 is moldable in various shapes when a force is applied and returns to an original shape when the force is removed (i.e., shape memory). In one embodiment, earpiece 100 is adapted to be removably coupled to a strap (e.g., strap 125) of an eyeshade, such as eyeshade 115. In one embodiment earpiece 100 includes material to cover at least one speaker (see FIGS. 17A and 17B). In one embodiment the speaker and the material operate to cancel ambient sound. In this embodiment, the earpiece uses noise canceling headphone type of speakers and speaker enclosure. In one embodiment earpiece 100 is made of layered materials.

In one embodiment earpiece 100 is covered in soft material, such as cotton blends, synthetic material (e.g., polyester), neoprene, compressible material, such as a foam polymer type material, velour, terry, etc. In one embodiment, earpiece 100 is made of a polymer foam material that is layered and has shape memory. In one embodiment earpiece 100 has an outer layer and an inner layer, and a cushion layer disposed between the outer layer and the inner layer. In this embodiment the inner layer covers a speaker (e.g., speaker 1710 in FIG. 17A-B). In this embodiment, earpiece 100 can be forced into different shapes and in a compressed size. When the force is removed, earpiece 100 returns to its original shape and size. In one embodiment, earpiece 100 does not include a speaker. In this embodiment, earpiece 100 is used for noise suppression.

In one embodiment earpiece 100 includes plug or wire 1120 (see FIG. 11, reference 1120). Plug 1120 receives a cord to connect to a sound source, such as a radio, a stereo system, an airplane entertainment system, a personal entertainment device (e.g., MP3 player, compact disk player, notebook computer, etc.). In another embodiment, earpiece 100 includes a cord to plug into the above-mentioned sound sources.

In one embodiment earpiece 100 includes a headphone speaker 1710 (see FIG. 17A-B) that is connected to first side 130. In this embodiment earpiece 100 emits sound waves to a user. It should be noted that typical headphone speakers can be used with the above described embodiments. Earpiece 100 has an inner depth that allows a person's ear from being in direct contact with headphone speaker 510.

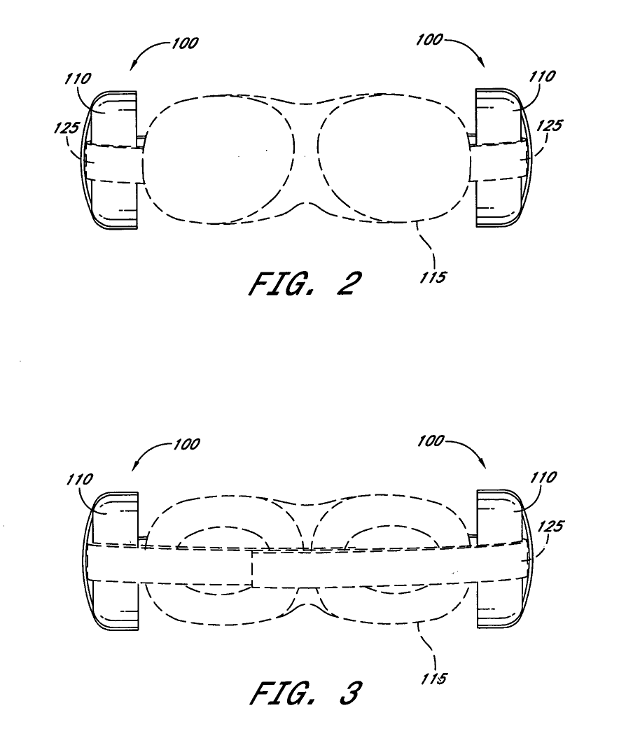

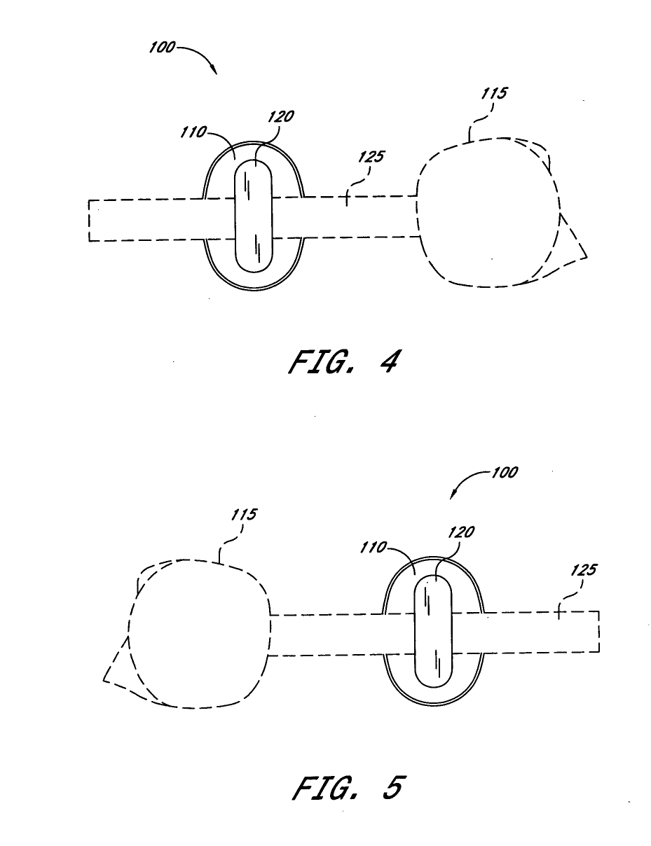

FIG. 2 illustrates a front view of an embodiment including two earpieces 100. In one embodiment, earpieces 100 are removably connected to strap 125. In one embodiment, strap 125 is connected to eyeshade 115. FIG. 3 illustrates a rear view of the embodiment illustrated in FIG. 2.

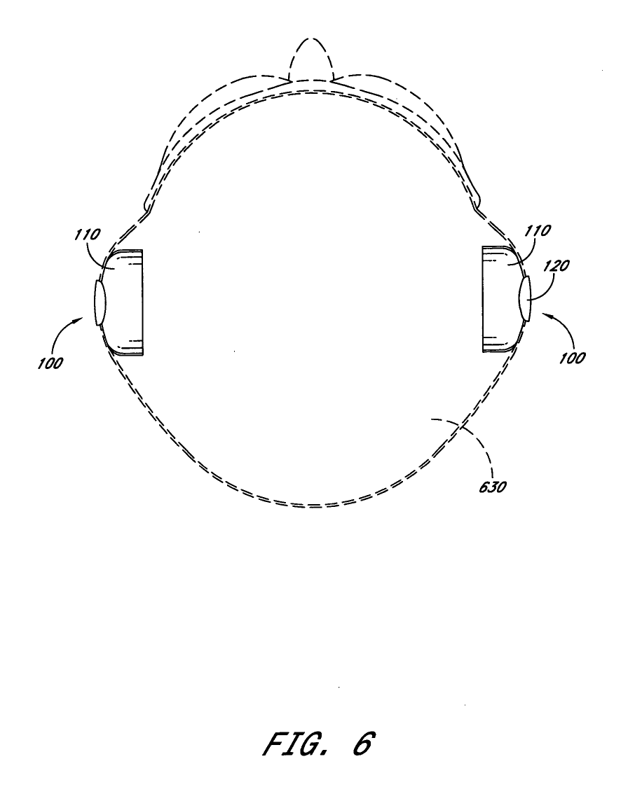

FIG. 4 illustrates a right side view of an embodiment including one or two earpieces 100. FIG. 5 illustrates a left side view of an embodiment including one or two earpieces 100. FIG. 6 illustrates a bottom plan view of an embodiment including two earpieces 100 connected to strap 125 and shown as viewed on a person's head 630 wearing eyeshade 115 with strap 125.

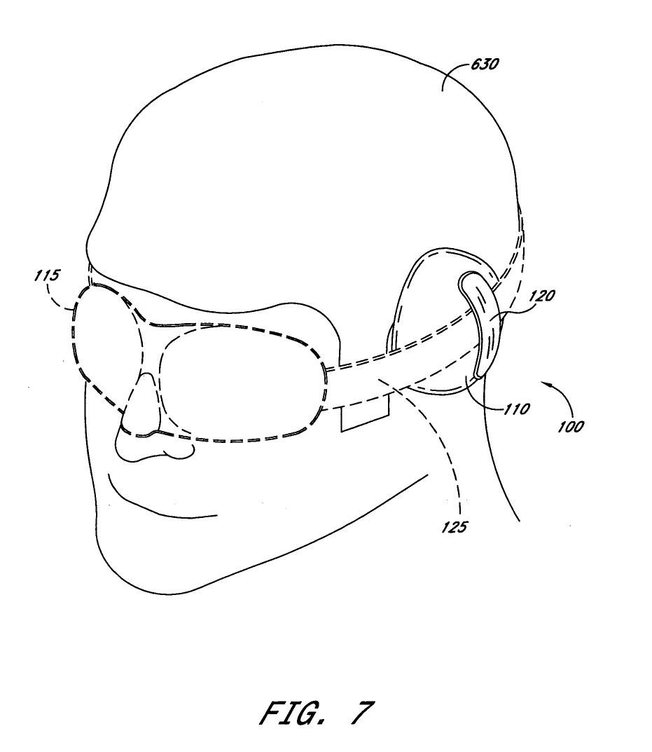

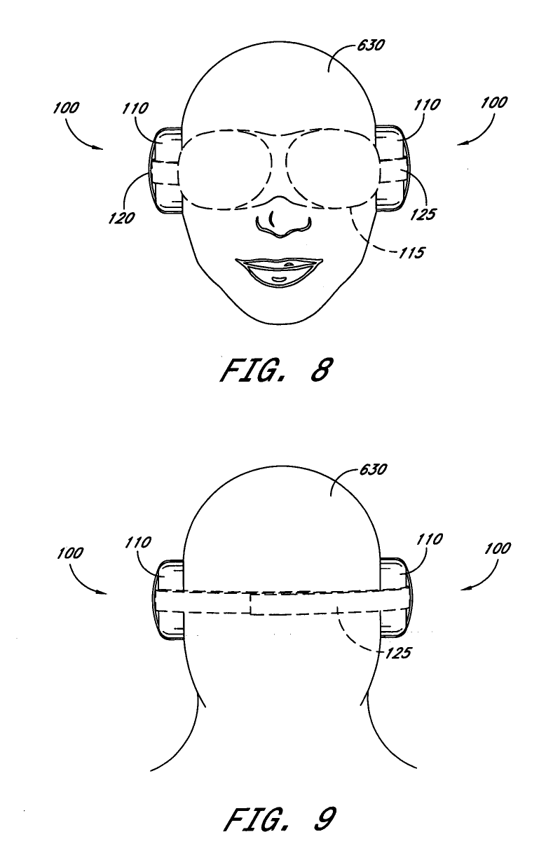

FIG. 7 illustrates a perspective view of an embodiment including one or two earpieces 100 connected to strap 125 and shown as viewed on a person wearing eyeshade 115 with strap 125 on their head 630. FIG. 8 illustrates a front view of an embodiment including two earpieces 100 connected to strap 125 and shown as viewed on a person wearing eyeshade 115 with strap 125 on their head 630. FIG. 9 illustrates a rear view of an embodiment including two earpieces 100 connected to strap 125 and shown as viewed on a person wearing eyeshade 115 with strap 125 on their head 630.

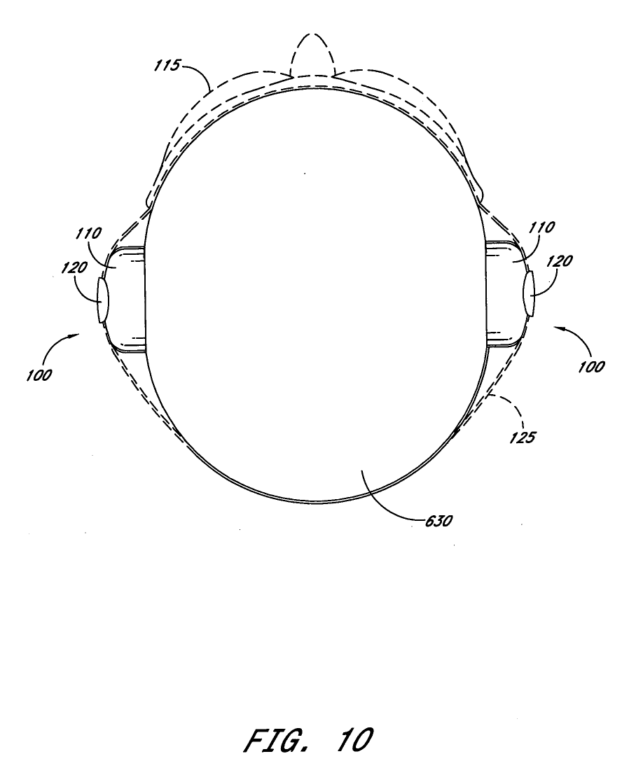

FIG. 10 illustrates a top plan view of an embodiment including two earpieces 100 connected to strap 125 and shown as viewed on a person's head 630 wearing eyeshade 115 with strap 125.

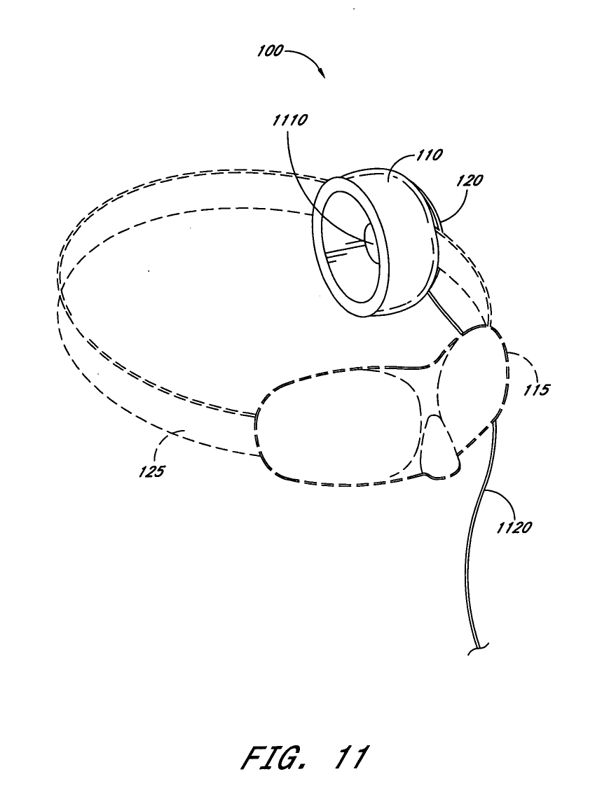

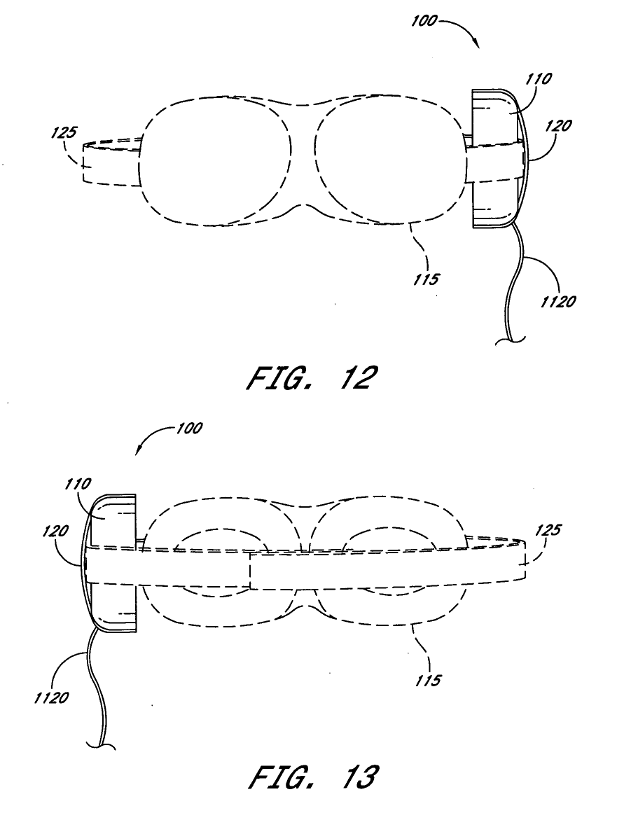

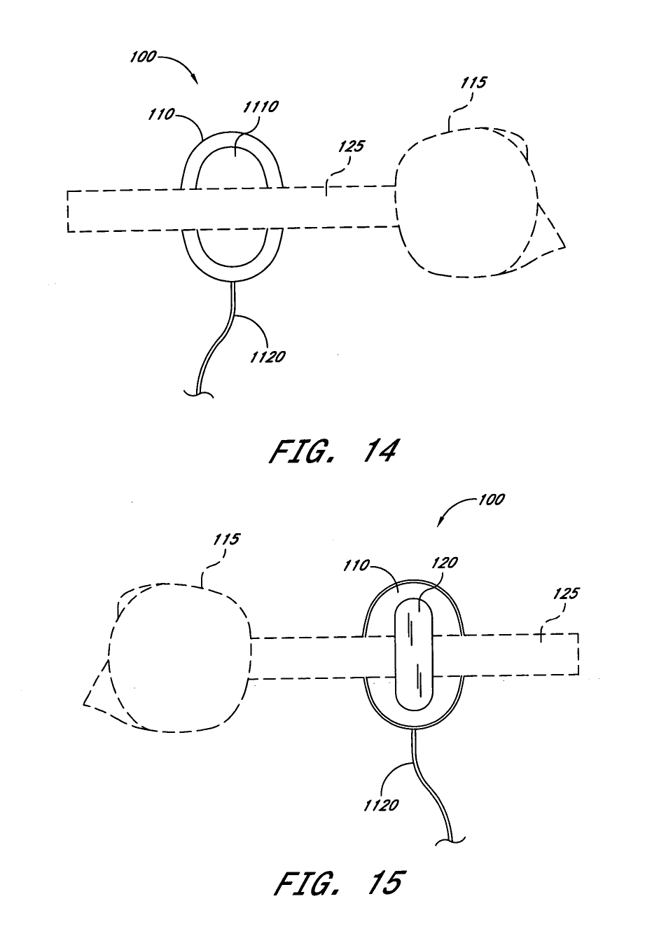

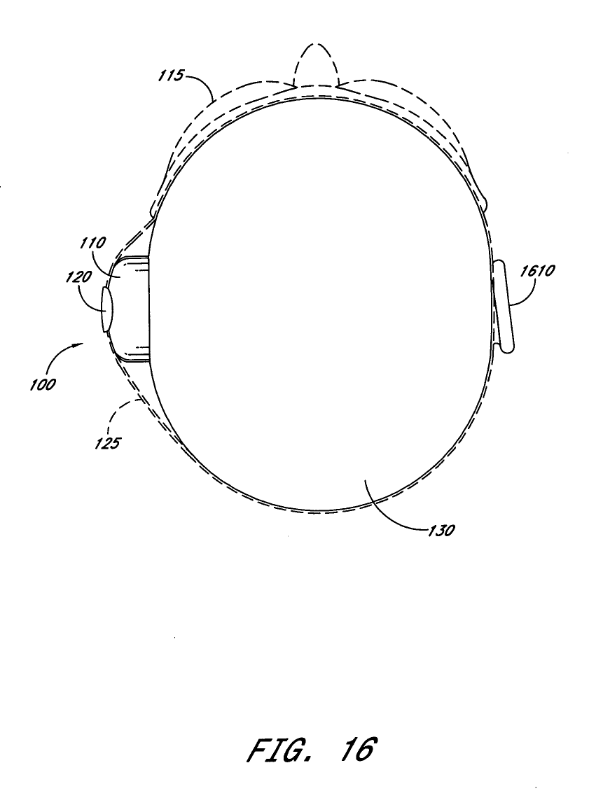

FIG. 11 illustrates a perspective view of earpiece 100 connected to strap 125 of eyeshade 115. In one embodiment, earpiece 100 includes a headphone cord 1120 connected to a headphone speaker in first side 1110. FIG. 12 illustrates a front view of the embodiment illustrated in FIG. 11. FIG. 13 illustrates a rear view of the embodiment illustrated in FIG. 11. FIG. 14 illustrates a right side view of the embodiment illustrated in FIG. 11. FIG. 15 illustrates a left side view of the embodiment illustrated in FIG. 11. FIG. 16 illustrates a top plan view of the embodiment illustrated in FIG. 11 shown on a person's head 130. In one embodiment, earpiece 100 covers a person's ear, such as an ear 1610.

FIG. 17A illustrates an embodiment including earpiece 100 having a headphone speaker 1710 disposed within first side 1110 and connected to a headphone cord 120. FIG. 17B illustrates a side cutout view of earpiece 100 showing inner cushion 1720. FIG. 17C illustrates a front side view of the embodiment illustrated in FIGS. 17A-B.

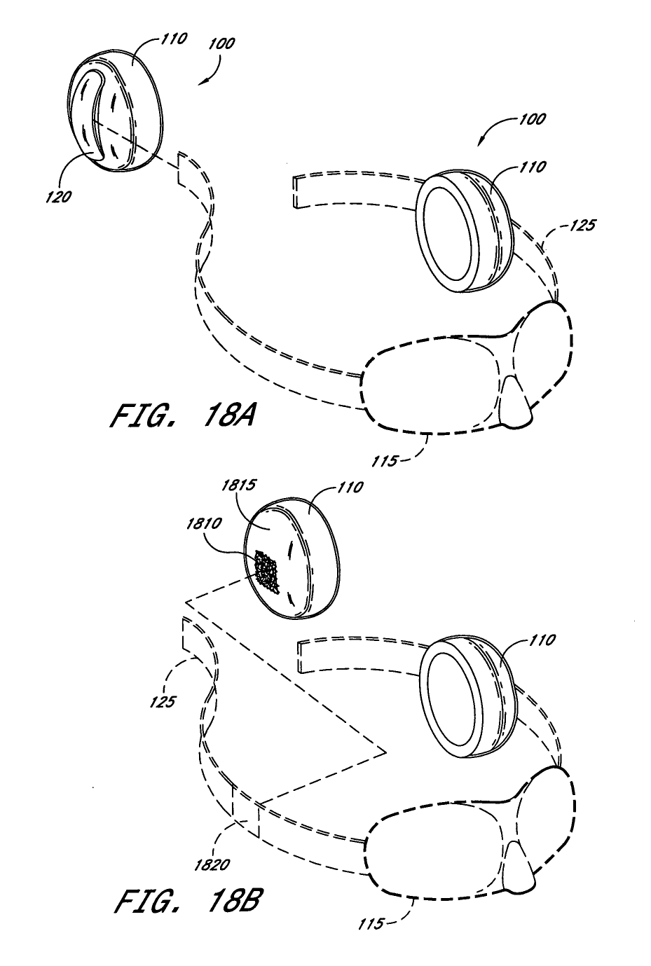

FIG. 18A illustrates an embodiment of a removable earpiece 100 showing how earpiece 100 is slid onto strap 125 connected to eyeshade 115 though loop 120. FIG. 18B illustrates an embodiment having hook fastener 1810 attached to a backside 1815 of earpiece 100 and loop fastener 1820 attached to strap 125 that is connected to eyeshade 115. In this embodiment, hook fastener 1810 removably connects to and disconnects from loop fastener 1820. In this embodiment, earpiece 100 can be connected to strap 125 while a person is wearing eyeshade 115 without removing strap 125.

In one embodiment earpiece 100 has an inner depth that can be _ inch, _ inch, 1 inch, etc. The inner depth of earpiece 100 allows a person's ear from being in direct contact with a headphone speaker, such as headphone speaker 1710. In one embodiment headphone speaker 1710 is covered with a sound permeable material to protect speaker 1710 from contacting a person's ear, dust, liquids, etc. In one embodiment earpiece 100 includes foam padding for the cushion. In another embodiment, earpiece 100 includes a liquid or gel filled portion for cushioning. In yet another embodiment earpiece 100 includes an air chamber that can be manually adjusted for the amount of air in the chamber through a valve.

Earpiece 100 is comfortable to wear by a person and does not have a small speaker placed in a person's ear, which can cause discomfort or irritation after remaining in an ear for a long time period.

In one embodiment the composition of the material covering earpiece 100 is such that it can be formed by a heat source in a press which molds composite materials. Since this embodiment of earpiece 100 is comprised of molded material, earpiece 100 has shape “memory.” Therefore, earpiece 100 can be folded, twisted, etc., and will retain its original formed shape. In another embodiment earpiece 100 is formed from one contiguous molded material formed by heat and pressure applied to the material. Since earpiece 100 can be forced into various shapes and sizes, earpiece 100 is easily stowed when traveling on a vehicle, such as an airplane, a ship or boat, a bus or car, a motorcycle, a train, etc. It should be noted that when earpiece 100 is placed under a force, such as a persons hands clasping or squishing earpiece 100, air is removed from the foam polymer layer. This reduces the volume of the foam polymer allowing earpiece 100 to displace less volume. When the force is removed, air fills spaces in the foam polymer returning earpiece 100 back to its original displacement and original shape.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus comprising:
a first earpiece having a first side and a second side; and
a loop portion coupled to the second side;
wherein the first side includes a hollowed ear portion adapted to fit over a person's ear, and the first earpiece is moldable in a plurality of shapes when a force is applied and returns to an original shape when the force is removed.

2. The apparatus of claim 1, wherein the first earpiece including material and at least one speaker

3. The apparatus of claim 2, the speaker and the material to cancel ambient sound.

4. The apparatus of claim 1, further comprising:
a plug, the plug to receive a cord to connect to a sound source.

5. The apparatus of claim 1, the first earpiece further comprising:
an outer portion and an inner portion, and
a cushion portion disposed between the outer portion and the inner portion, wherein the inner portion covers the first earpiece.

6. The apparatus of claim 2, wherein at least one speaker is disposed within the first earpiece.

7. The apparatus of claim 1, wherein the first earpiece further comprises a cushion portion coupled to the first side.

8. The apparatus of claim 1, further comprising a second earpiece.

9. The apparatus of claim 1, wherein the loop portion removably couples to a strap.

10. An earpiece system comprising:
a first removable earpiece and a second removable earpiece, the first and second removable earpieces each having a first side and a second side;
a first coupling loop coupled to the first removable earpiece;
a second coupling loop coupled to the second removable earpiece;

11. The earpiece system of claim 10, wherein the first removable earpiece and the second removable earpiece each including at least one speaker.

12. The earpiece system of claim 11, further comprising a material, wherein the at least one speaker and the material to cancel ambient sound.

13. The earpiece system of claim 11, wherein the at least one speaker is disposed within the first side of each of the first earpiece and the second earpiece, the at least one speaker to emit sound waves.

14. The earpiece system of claim 10, further comprising:
a cord, the cord plugs into a plug in one of the first earpiece and the second earpiece, the cord operates to connect to a sound source.

15. The earpiece system of claim 11, the first ear piece and the second earpiece each further comprising:
an outer portion and an inner portion, and
a cushion portion disposed between the outer portion and the inner portion, wherein the inner portion covers the at least one speaker.

16. The earpiece system of claim 10, wherein the first earpiece and the second earpiece are each separately moldable in a plurality of shapes when a force is applied and each of the first earpiece and the second earpiece return to an original shape when a force is removed.

17. The earpiece system of claim 10, wherein the each of the first coupling loop and the second coupling loop removably couples the first earpiece and the second earpiece to a strap of an eyeshade.

18. The earpiece system of claim 10, wherein each of the first earpiece and the second earpiece are sized to fit over a person's ear without touching the person's ear.

19. A headphone system comprising:
a first removable earpiece and a second removable earpiece, the first and second removable earpieces each having a first side and a second side and a loop portion,
wherein each of the first earpiece and the second earpiece are sized to fit over a person's ear without touching the person's ear.

20. The headphone system of claim 19, further comprising:
at least one speaker disposed within each of the first removable earpiece and the second removable earpiece.

21. The headphone system of claim 20, wherein the at least one speaker operates to one of cancel ambient sound and emit sound waves.

22. The headphone system of claim 19, further comprising:
a cord, wherein the cord plugs into a plug in one of the first earpiece and the second earpiece, and the cord operates to connect to a sound source.

23. The headphone system of claim 19, wherein the first earpiece and the second earpiece are each separately moldable in a plurality of shapes when a force is applied and each of the first earpiece and the second earpiece return to an original shape when a force is removed.
